(19) United States
(12) Patent Application Publication
(10) Pub. No.: US 2016/0364374 A1
(43) Pub. Date: Dec. 15, 2016

(54) VISUAL INDICATION FOR IMAGES IN A QUESTION-ANSWERING SYSTEM

(71) Applicant: International Business Machines Corporation, Armonk, NY (US)

(72) Inventors: Dan O'Connor, Milton, MA (US); William G. O'Keeffe, Tewksbury, MA (US); Cale R. Vardy, East York (CA); Bin A. Weng, Concord, MA (US)

(21) Appl. No.: 14/734,572

(22) Filed: Jun. 9, 2015

(51) Int. Cl. G06F 17/24; G06F 17/27; G06F 17/30

(52) U.S. Cl. CPC G06F 17/241; G06F 17/30525; G06F 17/30268; G06F 17/271; G06F 17/2785

(57) ABSTRACT

An answer to an input question may be formulated using a first corpus of information. Using the answer, a group of candidate images related to the answer from a second corpus of information may be identified. Using the answer and the group of candidate images, a group of modified images may be generated. Generating modified images may include marking, with a visual indicator, a portion of content in at least one image from the group of candidate images.

### BACKGROUND

The present disclosure relates to question-answering systems, and more specifically, to generating query relevant content from candidate images retrieved in response to an input question in a question-answering system.

Question-answering (QA) systems can be designed to receive input questions, analyze them, and return applicable answers. Using various techniques, QA systems can provide mechanisms for searching corpora (e.g., databases of source items containing relevant content) and analyzing the corpora to determine answers to an input question.

### SUMMARY

Aspects of the disclosure provide a method, system, and computer program product for generating query relevant content for an input question in a question-answering system. The method, system, and computer program product may include, in response to receiving an input question, formulating an answer to the input question by using a first corpus of information. Based upon the answer, a group of candidate images related to the input question from a second corpus of information may be identified. Using the answer and the group of candidate images, a group of modified images may be generated. Generating the modified images may include marking, with a visual indicator, a portion of content in at least one image from the group of candidate images.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an example computing environment for use with a question-answering (QA) system, according to embodiments of the present disclosure.

FIG. 2 depicts a block diagram of an example QA system configured to generate answers in response to one or more input queries, according to embodiments of the present disclosure.

FIG. 3 depicts a flowchart diagram of a method of generating query relevant content for an input question in a QA system, according to embodiments of the present disclosure.

FIG. 4A depicts a diagram of an example candidate image, according to embodiments of the present disclosure.

FIG. 4B depicts a diagram of an example modified candidate image including visual indicators, according to embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to question-answering systems, and more particular aspects relate to generating query relevant content from candidate images retrieved in response to an input question in a question-answering system. While the present disclosure is not necessarily limited to such applications, various aspects of the disclosure can be appreciated through a discussion of various examples using this context.

In a QA system, answers can be generated in response to input questions. In some embodiments, the QA system can be configured to receive an input question, analyze one or more data sources, and based on the analysis, generate answers. For example, in various embodiments, a QA system can analyze one or more data sources (which herein is used interchangeably with “corpus”) using a natural language processing technique. Based on the natural language analysis, the QA system can return an answer to a user. In embodiments, an answer can be data in various forms including, but not limited to, text, documents, images, video, and audio.

In some instances, an answer can include multiple forms of data. For example, an answer could be presented as text along with an accompanying image. Described further herein, the QA system can identify, in response to an input question, images associated with an answer by analyzing a corpus and determining a group of candidate images which are related to text in the answer. For example, the answer to an input question asking how to fill out a form could include text instructions that reference the form. Based on the text instructions, the QA system could analyze a corpus to identify an image of the referenced form.

Aspects of the present disclosure are directed to generating modified images for answers in a QA system. For example, in some embodiments, a QA system can generate modified images by identifying images for an answer in a QA system and marking content in the identified image to enhance the relevancy of the image.

For example, a QA system could return an answer that includes text and an accompanying image. According to embodiments of the present disclosure, a QA system could place visual indicators within the accompanying image to indicate one or more text elements of the answer. For example, an answer could include text instructions on how to fill out a form along with an image of the form. The QA system could analyze the image and locate a field in the form that is referenced in the text instructions. Described further herein, in various embodiments, the QA system could modify the image by marking the referenced field with a visual indicator. For example, the referenced field could be highlighted and/or annotated based on the text instructions. Accordingly, in some embodiments, the QA system could present a modified image of the referenced form which includes visual indicators to facilitate completion of the form.

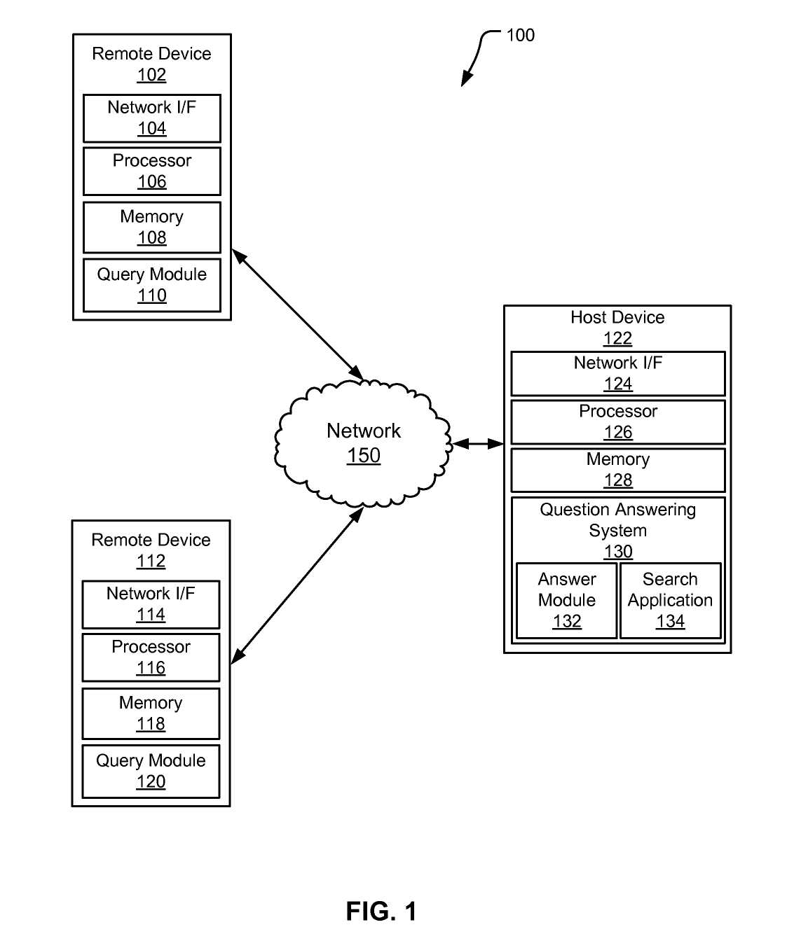

Referring now to FIG. 1, a diagram of a question-answering computing environment 100 can be seen, consistent with embodiments of the present disclosure. In certain embodiments, the environment 100 can include one or more remote devices 102 and 112 as well as one or more host devices 122. Remote devices 102 and 112 and host device 122 can be separated from each other and communicate over a network 150 in which the host device 122 comprises a central hub from which remote devices 102 and 112 can establish a communication connection. In some embodiments, the host device and remote devices can be configured in any type of suitable relationship (e.g., in a peer-to-peer relationship or other relationship).

In certain embodiments the network 150 can be implemented by various numbers of suitable communications media (e.g., wide area network (WAN), local area network (LAN), Internet, Intranet, etc.). In some embodiments, remote devices 102, 112 and host device 122 can be local to each other, and communicate via any appropriate local communication medium (e.g., local area network (LAN), hardwire, wireless link, Intranet, etc.). In certain embodiments, the network 100 can be implemented within a cloud computing environment, using one or more cloud computing services. Consistent with various embodiments, a cloud computing environment can include a network-based, distributed data processing system that provides one or more cloud computing services. In certain embodiments, a cloud computing environment can include various computers disposed within one or more data centers and configured to share resources over the network.

In certain embodiments, host device 122 can include a question answering system 130 (also referred to herein as a QA system) having a search application 134 and an answer module 132. In certain embodiments, the search application 134 can be implemented by a search engine and can be distributed across multiple computer systems. In embodiments, the search application 134 can be configured to search one or more databases or other computer systems for content that is related to a question input at the remote devices 102, 112 and/or the host device 122.

In certain embodiments, remote devices 102, 112 enable users to submit questions (e.g., search requests or other queries) to host device 122 to retrieve search results. For example, the remote devices 102, 112 can include a query module 110 (e.g., in the form of a web browser or other suitable software module) and present a graphical user (e.g., GUI, etc.) or other interface (e.g., command line prompts, menu screens, etc.) to solicit queries from users for submission to one or more host devices 122 and further to display answers/results obtained from the host device 122 in relation to such queries.

Consistent with various embodiments, host device 122 and remote devices 102, 112 can be computer systems equipped with a display or monitor. In certain embodiments, the computer systems can include at least one processor 106, 116, 126 memories 108, 118, 128 and/or internal or external network interface or communications devices 104, 114, 124 (e.g., modem, network cards, etc.), optional input devices (e.g., a keyboard, mouse, or other input device), and any commercially available and custom software (e.g., browser software, communications software, server software, natural language processing software, search engine and/or web crawling software, filter modules for filtering content based upon predefined criteria, etc.). In certain embodiments, the computer systems can include server, desktop, laptop, and hand-held devices. In addition, the answer module 132 can include one or more modules or units to perform the various functions of present disclosure embodiments described herein, and can be implemented by any combination of any quantity of software and/or hardware modules or units.

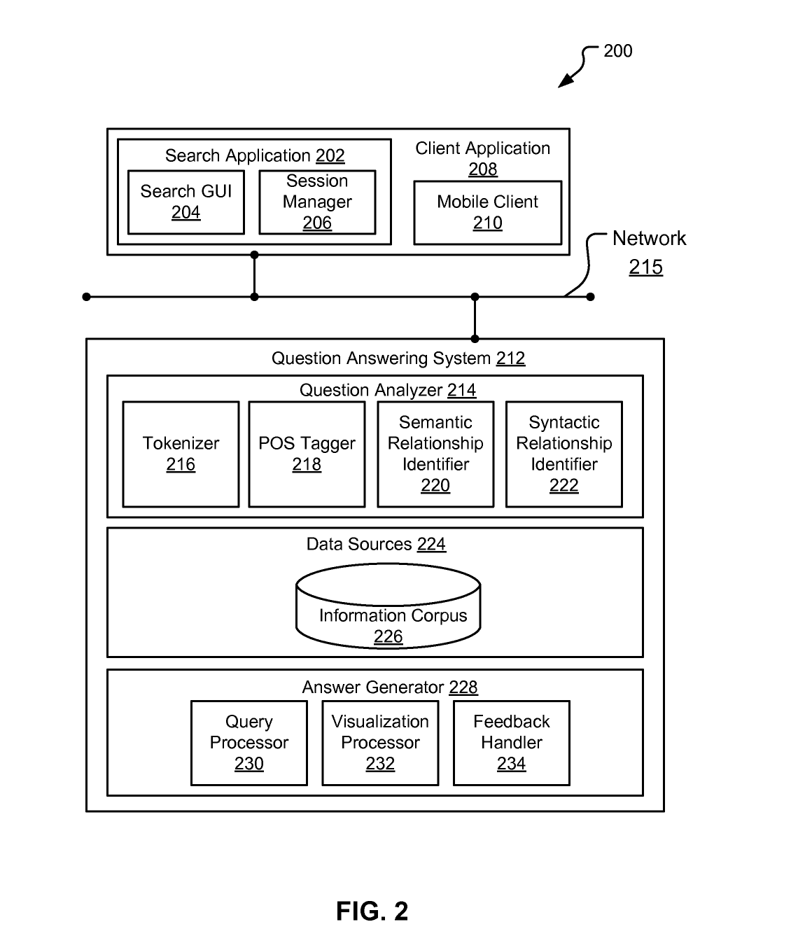

Referring now to FIG. 2, a block diagram illustrating a question-answering system to generate answers to one or more input questions can be seen, consistent with various embodiments of the present disclosure.

Aspects of FIG. 2 are directed toward a system architecture 200 of a question answering system 212 to generate answers to queries (e.g., input questions). In certain embodiments, one or more users can send requests for information to QA system 212 using a remote device (such as remote devices 102, 112 of FIG. 1). QA system 212 can perform methods and techniques for responding to the requests sent by one or more client applications 208. Client applications 208 can involve one or more entities operable to generate events dispatched to QA system 212 via network 215. In certain embodiments, the events received at QA system 212 can correspond to input questions received from users, where the input questions can be expressed in a natural language format.

A question (similarly referred to herein as a query) can be one or more words that form a search term or request for data, information or knowledge. A question can be expressed in natural language. In some embodiments, the input questions can be unstructured text. Questions can include various selection criteria and search terms. A question can be composed of linguistic features. In some embodiments, a question can include various keywords. In certain embodiments, using unrestricted syntax for questions posed by users is enabled. The use of restricted syntax results in a variety of alternative expressions for users to better state their needs.

Consistent with various embodiments, client applications 208 can include one or more components such as a search application 202 and a mobile client 210. Client applications 208 can operate on a variety of devices. Such devices include, but are not limited to, mobile and handheld devices, such as laptops, mobile phones, personal or enterprise digital assistants, and the like; personal computers, servers, or other computer systems that can access the services and functionality provided by QA system 212. For example, mobile client 210 can be an application installed on a mobile or other handheld device. In certain embodiments, mobile client 210 can dispatch query requests to QA system 212.

Consistent with various embodiments, search application 202 can dispatch requests for information to QA system 212. In certain embodiments, search application 202 can be a client application to QA system 212. In certain embodiments, search application 202 can send requests for answers to QA system 212. Search application 202 can be installed on a personal computer, a server or other computer system. In certain embodiments, search application 202 can include a search graphical user interface (GUI) 204 and session manager 206. Users can enter questions in search GUI 204. In certain embodiments, search GUI 204 can be a search box or other GUI component, the content of which represents a question to be submitted to QA system 212. Users can authenticate to QA system 212 via session manager 206. In certain embodiments, session manager 206 keeps track of user activity across sessions of interaction with the QA system 212. Session manager 206 can keep track of what questions are submitted within the lifecycle of a session of a user. For example, session manager 206 can retain a succession of questions posed by a user during a session. In certain embodiments, answers produced by QA system 212 in response to questions posed throughout the course of a user session can also be retained. Information for sessions managed by session manager 206 can be shared between computer systems and devices.

In certain embodiments, client applications 208 and QA system 212 can be communicatively coupled through network 215, e.g. the Internet, intranet, or other public or private computer network. In certain embodiments, QA system 212 and client applications 208 can communicate by using Hypertext Transfer Protocol (HTTP) or Representational State Transfer (REST) calls. In certain embodiments, QA system 212 can reside on a server node. Client applications 208 can establish server-client communication with QA system 212 or vice versa. In certain embodiments, the network 215 can be implemented within a cloud computing environment, or using one or more cloud computing services. Consistent with various embodiments, a cloud computing environment can include a network-based, distributed data processing system that provides one or more cloud computing services.

Consistent with various embodiments, QA system 212 can respond to the requests for information sent by client applications 208, e.g., posed questions by users. QA system 212 can generate answers to the received questions. In certain embodiments, QA system 212 can include a question analyzer 214, data sources 224, and answer generator 228. Question analyzer 214 can be a computer module that analyzes the received questions. In certain embodiments, question analyzer 214 can perform various methods and techniques for analyzing the questions syntactically and semantically. In certain embodiments, question analyzer 214 can parse received questions. Question analyzer 214 can include various modules to perform analyses of received questions. For example, computer modules that question analyzer 214 can encompass include, but are not limited to a tokenizer 216, part-of-speech (POS) tagger 218, semantic relationship identification 220, and syntactic relationship identification 222.

Consistent with various embodiments, tokenizer 216 can be a computer module that performs lexical analysis. Tokenizer 216 can convert a sequence of characters into a sequence of tokens. Tokens can be string of characters typed by a user and categorized as a meaningful symbol. Further, in certain embodiments, tokenizer 216 can identify word boundaries in an input question and break the question or any text into its component parts such as words, multiword tokens, numbers, and punctuation marks. In certain embodiments, tokenizer 216 can receive a string of characters, identify the lexemes in the string, and categorize them into tokens.

Consistent with various embodiments, POS tagger 218 can be a computer module that marks up a word in a text to correspond to a particular part of speech. POS tagger 218 can read a question or other text in natural language and assign a part of speech to each word or other token. POS tagger 218 can determine the part of speech to which a word corresponds based on the definition of the word and the context of the word. The context of a word can be based on its relationship with adjacent and related words in a phrase, sentence, question, or paragraph. In certain embodiments, context of a word can be dependent on one or more previously posed questions. Examples of parts of speech that can be assigned to words include, but are not limited to, nouns, verbs, adjectives, adverbs, and the like. Examples of other part of speech categories that POS tagger 218 can assign include, but are not limited to, comparative or superlative adverbs, “wh-adverbs,” conjunctions, determiners, negative particles, possessive markers, prepositions, “wh-pronouns,” and the like. In certain embodiments, POS tagger 216 can tag or otherwise annotates tokens of a question with part of speech categories. In certain embodiments, POS tagger 216 can tag tokens or words of a question to be parsed by QA system 212.

Consistent with various embodiments, semantic relationship identifier 220 can be a computer module that can identify semantic relationships of recognized entities in questions posed by users. In certain embodiments, semantic relationship identifier 220 can determine functional dependencies between entities, the dimension associated to a member, and other semantic relationships.

Consistent with various embodiments, syntactic relationship identifier 222 can be a computer module that can identify syntactic relationships in a question composed of tokens posed by users to QA system 212. Syntactic relationship identifier 222 can determine the grammatical structure of sentences, for example, which groups of words are associated as “phrases” and which word is the subject or object of a verb. In certain embodiments, syntactic relationship identifier 222 can conform to a formal grammar.

In certain embodiments, question analyzer 214 can be a computer module that can parse a received query and generate a corresponding data structure of the query. For example, in response to receiving a question at QA system 212, question analyzer 214 can output the parsed question as a data structure. In certain embodiments, the parsed question can be represented in the form of a parse tree or other graph structure. To generate the parsed question, question analyzer 214 can trigger computer modules 122-134. Question analyzer 214 can use functionality provided by computer modules 216-222 individually or in combination. Additionally, in certain embodiments, question analyzer 214 can use external computer systems for dedicated tasks that are part of the question parsing process.

Consistent with various embodiments, the output of question analyzer 214 can be used by QA system 212 to perform a search of one or more data sources 224 to retrieve information to answer a question posed by a user. In certain embodiments, data sources 224 can include data warehouses, information corpora, data models, and document repositories. In certain embodiments, the data source 224 can be an information corpus 226. The information corpus 226 can enable data storage and retrieval. In certain embodiments, the information corpus 226 can be a storage mechanism that houses a standardized, consistent, clean and integrated form of data. The data can be sourced from various operational systems. Data stored in the information corpus 226 can be structured in a way to specifically address reporting and analytic requirements. In one embodiment, the information corpus can be a relational database. In some example embodiments, data sources 224 can include one or more document repositories.

In certain embodiments, answer generator 228 can be a computer module that generates answers to posed questions. Examples of answers generated by answer generator 228 can include, but are not limited to, answers in the form of natural language sentences, images, reports, charts, or other analytic representation, raw data, web pages, and the like.

Consistent with various embodiments, answer generator 228 can include query processor 230, visualization processor 232 and feedback handler 234. When information in a data source 224 matching a parsed question is located, a technical query associated with the pattern can be executed by query processor 230. Based on retrieved data by a technical query executed by query processor 230, visualization processor 232 can render visualization of the retrieved data, where the visualization represents the answer. In certain embodiments, visualization processor 232 can render various analytics to represent the answer including, but not limited to, images, charts, tables, dashboards, maps, and the like. In certain embodiments, visualization processor 232 can present the answer to the user in understandable form.

In certain embodiments, feedback handler 234 can be a computer module that processes feedback from users on answers generated by answer generator 228. In certain embodiments, users can be engaged in dialog with the QA system 212 to evaluate the relevance of received answers. Answer generator 228 can produce a list of answers corresponding to a question submitted by a user. The user can rank each answer according to its relevance to the question. In certain embodiments, the feedback of users on generated answers can be used for future question answering sessions.

The various components of the QA system architecture 200 can be used to implement aspects of the present disclosure. For example, the client application 208 could be used to receive a question from a user. The question analyzer 214 could, in certain embodiments, be used to process a natural language question for which relevant images can be provided. Further, the question answering system 212 could, in certain embodiments, be used to perform a search of an information corpus 226 for a set of images that are related to an answer to an input question to the QA system. The answer generator 228 can be used to identify a group of candidate images based on the results of the search performed by the question answering system 212. In certain embodiments, the determination of the set of the candidate images can be based on confidence values.

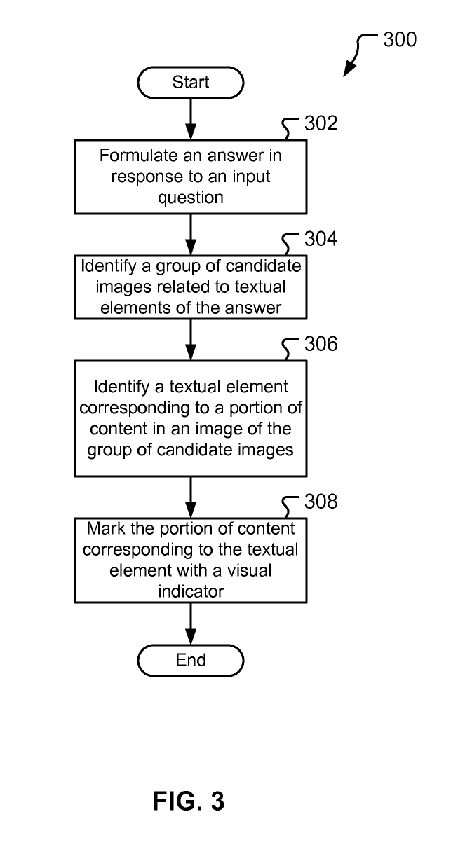

Referring now to FIG. 3, a flowchart diagram of a method 300 of generating query relevant content for an input question in a QA system can be seen, according to embodiments of the present disclosure. In various embodiments, the one or more operations in the method 300 can be implemented in a question answering environment, such as by QA system architecture 200. Individual operations at individual blocks discussed separately may be performed simultaneously or temporarily.

At block 302, an answer in response to an input question is formulated. In certain embodiments, formulating an answer to an input question can include using a QA system such as the QA system of FIG. 2. In some embodiments, formulating the answer to an input question can include receiving a question in a QA system from a client. A question analyzer can parse the input question, and determine, using a natural language processing technique (e.g. tokenizer, POS tagger, semantic relationship identifier, syntactic relationship identifier, etc.) semantic and syntactic relationships present in the question. The QA system can then consult a data source, such as an information corpus, to retrieve information to answer the question. As described herein, in embodiments, formulating the answer to a question can include using an answer generator to organize and render the information as text elements, images, video, and/or other suitable forms. In some embodiments, text elements of the answer are portions of the answer that are represented in natural language form. For example, a question asking “How do I open an application on the desktop of my computer?” could include an answer with text elements of “Double click the application icon.”

In certain embodiments, an answer could include one or more textual elements, such as a list of steps written in natural language text. In some embodiments, each step in the list could be a textual element. For example, in response to the input question “How do I declare that I'm single on Form 1040?” an answer could be text from the IRS instructions on form 1040, such as “You can check the box on line 1 if any of the following was true on Dec. 31, 2013. You were never married. You were legally separated according to your state law under a decree of divorce or separate maintenance. But if, at the end of 2013, your divorce was not final (an interlocutory decree), you are considered married and cannot check the box on line 1. You were widowed before Jan. 1, 2013, and did not remarry before the end of 2013. But if you have a dependent child, you may be able to use the qualifying widow(er) filing status. See instructions for line 5.”

At block 304, a group of candidate images related to text elements of the answer are identified. As described herein, in embodiments, the group of candidate images can be identified from a corpus of information containing documents and information accessible for search by a QA system. For example, using the IRS form example from above, the IRS form containing the instructions includes the words “filing status”, “line 1”, and “legally separated”. The input question references form 1040, and the format of the answer document (e.g., Form 1040) is associated with line 1 of the Filing Status section. Therefore, the QA system may identify candidate images from a corpus of information related to IRS rules and filling out tax returns.

In some embodiments, the group of candidate images can be located within a corpus of information that is distinct from the corpus of information that was used to produce the textual elements of the answer. For example, the answer to the input question could be formulated based on information in a first source and the group of candidate images could be identified from one or more different sources. For example, for an input question of “What cable is needed to transmit video from my home theater PC to my TV?” the answer cold be generated from text in a TV instruction manual, while images relevant to the answer (e.g., images showing the specific cable) could be identified from a technical blog or other source. In some embodiments, the answer to the input question and the group of candidate images could be formulated based on information in a single source.

In embodiments, the operations performed at block 304 can include using the answer to the input question to identify the group of candidate images. For example, a QA system can identify the group of candidate images from images that are related to the answer. In various embodiments, images can be determined to be related to the answer based on confidence values generated by the QA system. For example, in certain embodiments, confidence values for the images could be based on the similarity of content in the images and one or more text elements of the answer.

For example, in embodiments, the QA system can use optical character recognition techniques to extract text from the images. The QA system can be configured to use a natural language processing technique to compare text extracted from the images to textual elements of the answer. The natural language processing technique can be configured to recognize keywords, contextual information, and metadata tags associated with the images and the textual elements of the answer to the input question. In certain embodiments, the natural language processing technique can be configured to analyze summary information, keywords, figure captions, and text descriptions coupled with a set of images, and use syntactic and semantic elements present in this information to identify the group of candidate images. The syntactic and semantic elements can include information such as word frequency, word meanings, text font, italics, hyperlinks, proper names, noun phrases, and the context of surrounding words. Other syntactic and semantic elements are also possible. Based on comparing, the QA system can assign a confidence measure value to the group of candidate images. Further, in embodiments, the QA system can be configured to select candidate images from images that have a confidence measure value greater than a threshold value.

At block 306, a textual element corresponding to a portion of content in at least one image of the group of candidate images is identified. In some embodiments, the QA system could use optical character recognition techniques along with natural language processing techniques to identify textual elements in the group of candidate images.

As described herein, in embodiments, textual elements are portions of natural language text generated as an answer to an input question. In embodiments, the textual elements can be identified based on semantic and/or syntactic characteristics which forms natural breaks in the answer. For example, if the answer in response to a question about IRS filing statuses was a list of steps, the QA system could identify textual elements as each step in the list, based on the syntactic listing of steps with numerals. Additionally, the QA system could use semantic analysis to identify words that indicate steps (e.g. step, firstly, secondly, etc.). The QA system could identify answer segments based on the semantic analysis. In another example, continuing the example with the input question “How do I declare that I'm single on Form 1040?”, the textual element may be identified as “You can check the box on line 1.”

At block 308, a portion of content in at least one candidate image is marked with a visual indicator. In certain embodiments, the QA system can edit images from the group of candidate images to emphasize portions of the image that correspond to textual elements. In various embodiments, the QA system can edit the images by marking portions with a visual indicator. In some embodiments, the visual indicator could include highlighting a portion of the image. In other embodiments, the visual indictor could include adding a text annotation to the image.

For example, continuing the IRS form example, if the answer included the textual element that stated “You can check the box on line 1”, the QA system could locate the checkbox and line 1 associated with the input question within the IRS 1040 form. In some embodiments, the QA system could annotate the image with a portion of the answer element. For example, in the IRS form, the QA system could highlight line 1 as well as mark (e.g., in the form of an arrow) the checkbox associated with the text element. Also, the QA system could add an instruction of “check box” next to the checkbox within the image. In certain embodiments, the modified image could then be presented to a user along with the answer. In other embodiments, in addition to providing related images and modified related images, the QA system may provide hyperlinks to related documents and/or content for viewing and/or downloading.

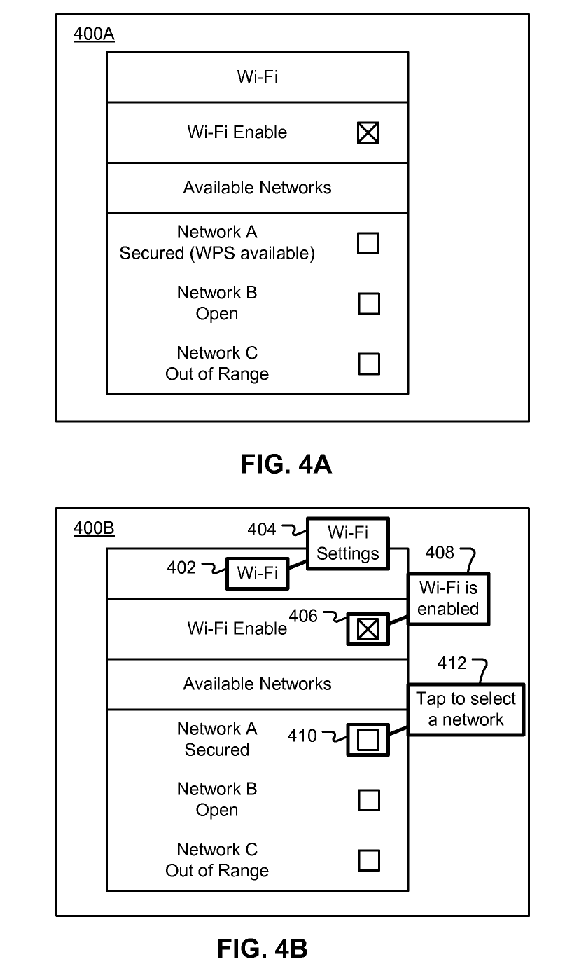

FIG. 4A depicts a diagram of an example candidate image 400A, according to embodiments of the present disclosure. For example, in embodiments, a QA system could receive an input question of “How do I connect my mobile device to a Wi-Fi network?” As described herein, the QA system could use a natural language processing technique to formulate an answer including one or more text elements.

For example, the answer could include the text: “1. Locate Wi-Fi in the “Wireless and Network” section; 2. Tap on the Wi-Fi icon to open the Wi-Fi networks settings menu; 3. When the box next to the Wi-Fi title is checked, that indicates that Wi-Fi is enabled; 4. Tap the required network in the list; 5. Follow the instructions that appear on your phone screen then select the security settings if required; 6. If the Wi-Fi network that you choose asks for a password, then enter the password; 7. Tap Connect button.”

The answer references the Wi-Fi settings menu of the user's mobile device. As described herein, the QA system can analyze the semantic and syntactic content of the answer and, based on the analysis, identify an image 400A of the Wi-Fi setting menu in a corpus. As described herein, the QA system can identify image 400A based on a determination that the image 400A is related to the answer. For example, the QA system could use optical character recognition techniques to identify text in image 400A and compare it to text in the answer. In some embodiments, the QA system could identify image 400A based on the name of the file, metadata or other information.

FIG. 4B depicts a diagram of an example modified candidate image 400B including visual indicators, according to embodiments of the present disclosure. As described herein, the QA system can use natural language processing techniques along with optical character recognition techniques to identify portions of content in the image 400B that correspond to textual elements of the answer. For instance, using the example above, the answer includes the text: “Tap on the Wi-Fi icon to open the Wi-Fi networks settings menu; 3. When the box next to the Wi-Fi title is checked, that indicates that Wi-Fi is enabled; 4. Tap the required network in the list.” The steps listed in the text answer correspond with portions of content 402, 406, and 410.

Based upon the answer, the QA system could identify portions of content 402, 406, and 410 in image 400B and could modify the image 400B using visual indicators 404, 408, and 412. In some embodiments, the visual indicators can include an annotation. For example, visual indicator 404 includes text of “Wi-Fi Settings” based on the text element “Tap on the Wi-Fi icon to open the Wi-Fi networks settings menu” of the answer. Visual indicator 408 includes “Wi-Fi is enabled” based on the text element of “When the box next to the Wi-Fi title is checked, that indicates that Wi-Fi is enabled” of the answer. Visual indicator 412 includes “Tap to select a network” based on the text element “4. Tap the required network in the list.” In some embodiments, the visual indicators 404, 408, 412 can have text colors based on the image. For example, the QA system could select text color for the visual indicators 404, 408, 412 based on a background color for the image. In some embodiments, the visual indicator could include a solid background for annotated text to reduce interference with other text in the image 400B. In some embodiments, the visual indicators could include highlighting portions of content in the image 400B. In other embodiments, visual indictors could include a combination of highlighting and annotation of portions of content in the image 400B.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for generating query relevant content for an input question in a question-answering system, the method comprising:
formulating, in response to receiving an input question, an answer to the input question using a first corpus of information;
identifying, using the answer, a group of candidate images from a second corpus of information, the group of candidate images relating to the answer to the input question;
generating, using the answer and the group of candidate images, a group of modified images, wherein the group of modified images are generated by marking, with a visual indicator, a portion of content in at least one candidate image from the group of candidate images.

2. The method of claim 1, wherein marking with the visual indicator, the portion of content includes:
annotating, using the answer, the portion of content in the at least one candidate image.

3. The method of claim 2, wherein annotating the portion of content in the at least one candidate image includes:
determining a background color for the portion of content in the at least one candidate image; and
selecting, using the background color, a font color for annotating the portion of content in the at least one candidate image.

4. The method of claim 1, wherein marking, with the visual indicator, the portion of content includes:
highlighting, using the answer, the portion of content in the at least one candidate image.

5. The method of claim 4, wherein highlighting the portion of content in the at least one candidate image includes:
determining a background color for the portion of content in the at least one candidate image;
selecting, using the background color, a highlighting color for highlighting the portion of content in the at least one candidate image.

6. The method of claim 1, wherein identifying the group of candidate images includes providing access to the second corpus of information.

7. The method of claim 1, wherein identifying the group of candidate images includes:
determining, using a natural language processing technique configured to parse semantic and syntactic content of at least one of the input question and the answer, a set of subject features;
comparing the set of subject features to a set of images included in the second corpus of information; and
selecting, as the group of candidate images, a subset of the set of images that correspond to the set of subject features.

8. A system for generating query relevant content for an input question in a question-answering system, the system comprising:
a processor; and
a computer readable storage medium having program instructions embodied therewith, the program instructions executable by the processor to cause the system to perform a method, the method comprising:
formulating, in response to receiving an input question, an answer to the input question using a first corpus of information;
identifying, using the answer, a group of candidate images from a second corpus of information, the group of candidate images relating to the answer to the input question;
generating, using the answer and the group of candidate images, a group of modified images, wherein the group of modified images are generated by marking, with a visual indicator, a portion of content in at least one candidate image from the group of candidate images.

9. The system of claim 8, wherein marking with the visual indicator, the portion of content includes:
annotating, using the answer, the portion of content in the at least one candidate image.

10. The system of claim 9, wherein annotating the portion of content in the at least one candidate image includes:
determining a background color for the portion of content in the at least one candidate image; and
selecting, using the background color, a font color for annotating the portion of content in the at least one candidate image.

11. The system of claim 8, wherein marking with the visual indicator, the portion of content includes:
highlighting, using the answer, the portion of content in the at least one candidate image.

12. The system of claim 11, wherein highlighting the portion of content in the at least one candidate image includes:
determining a background color for the portion of content in the at least one candidate image;
selecting, using the background color, a highlighting color for highlighting the portion of content in the at least one candidate image.

13. The system of claim 8, wherein identifying the group of candidate images includes providing access to the second corpus of information.

14. The system of claim 8, wherein identifying the group of candidate images includes:
determining, using a natural language processing technique configured to parse semantic and syntactic content of at least one of the input question and the answer, a set of subject features;
comparing the set of subject features to a set of images included in the second corpus of information; and
selecting, as the group of candidate images, a subset of the set of images that correspond to the set of subject features.

15. A computer program product for generating query relevant content for an input question in a question-answering system, the computer program product comprising a computer readable storage medium having program instructions embodied therewith, wherein the computer readable storage medium is not a transitory signal per se, the program instructions executable by a computer to cause the computer to perform a method, the method comprising:
formulating, in response to receiving an input question, an answer to the input question using a first corpus of information;
identifying, using the answer, a group of candidate images from a second corpus of information, the group of candidate images relating to the answer to the input question;
generating, using the answer and the group of candidate images, a group of modified images, wherein the group of modified images are generated by marking, with a visual indicator, a portion of content in at least one candidate image from the group of candidate images.

16. The computer program product of claim 15, wherein marking with the visual indicator, the portion of content includes:
annotating, using the answer, the portion of content in the at least one candidate image.

17. The computer program product of claim 16, wherein annotating the portion of content in the at least one candidate image includes:
determining a background color for the portion of content in the at least one candidate image; and
selecting, using the background color, a font color for annotating the portion of content in the at least one candidate image.

18. The computer program product of claim 15, wherein marking with the visual indicator, the portion of content includes:
highlighting, using the answer, the portion of content in the at least one candidate image.

19. The computer program product of claim 18, wherein highlighting the portion of content in the at least one candidate image includes:
determining a background color for the portion of content in the at least one candidate image;
selecting, using the background color, a highlighting color for highlighting the portion of content in the at least one candidate image.

20. The computer program product of claim 15, wherein identifying the group of candidate images includes:
determining, using a natural language processing technique configured to parse semantic and syntactic content of at least one of the input question and the answer, a set of subject features;
comparing the set of subject features to a set of images included in the second corpus of information; and
selecting, as the group of candidate images, a subset of the set of images that correspond to the set of subject features.
